(19) United States
(12) Patent Application Publication
(10) Pub. No.: US 2004/0194605 A1
(43) Pub. Date: Oct. 7, 2004

(54) Cutting device

(76) Inventor: Gunther Weber, Zachow (DE)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/490,798

(22) PCT Filed: Jul. 31, 2002
(86) PCT No.: PCT/EP02/08558

(30) Foreign Application Priority Data
Sep. 27, 2001 (DE) 101 47 617.5

(51) Int. Cl. B26D 1/12

(52) U.S. Cl. 83/663

(57) ABSTRACT

The invention relates to a device for cutting food products (10) having, in particular, an irregular internal structure, such as for example sausages or ham. By means of the present device, said products (10) are cut in slices (20), shaped in particular in shingled or stacked portions and evacuated from a cutting area (16). Said cutting device comprises a cutting edge, on which said products are cut, a device for evacuating the product slices (20), which is formed in particular by an endless belt (24) and at least one lighting device (34) for illuminating the cutting area (16). According to the present invention, said lighting device (34) is arranged in a half-space in front of the cutting area (16) under the cutting edge (22), such that the light passes through a gap (26) between the cutting edge (22) and the evacuation device (24). A cleaning device (50) for cleaning said lighting device (34) and/or gap (26) is also provided.

The invention relates to an apparatus for the slicing of food products, in particular with an irregular internal structure, such as sausage or ham, with which the products are cut into slices and portions, in particular overlapping portions, or stacked portions are formed and are transported away from a slicing region and which has a cutting edge at which the products are cut, a device for the transporting away of the product slices, in particular formed by an endless belt, and at least one lighting device for the illumination of the slicing region.

Such slicer apparatuses are generally known, e.g. from DE 199 06 021 A1. The illumination of the slicing region serves for the determination of information on the contour and on the structure of the product or of the product slices in order to ensure the further processing of product slices of respectively similar quality, for example with the same fat portion and/or with the same weight. The illumination of the slicing region typically takes place with known slicer apparatuses by lighting devices disposed above the cutting edge and/or above the device for the transporting away of the product slices.

The underlying object of the invention is to provide an apparatus of the initially named kind which has a design which is as simple as possible and in which the quality of the illumination is ensured in the long term.

An apparatus having the features of claim 1 is provided to satisfy this object.

The apparatus in accordance with the invention is an apparatus of the initially named kind which has been further developed such that the lighting device is arranged beneath the cutting edge in the half-space disposed in front of the slicing region such that the illumination takes place through a gap between the cutting edge and the device for transporting away and such that a cleaning device is provided for the cleaning of the lighting device and/or of the gap.

The positioning of the lighting device beneath the cutting edge can be shown to be advantageous, for example, when an illumination of the slicing region from above the cutting edge from the half-space disposed in front of the slicing region is unwanted or difficult to realize or if, in addition to other lighting devices, in particular lighting devices positioned above the cutting edge, a lighting device is required which illuminates the slicing region from a different direction and in particular illuminates at a different angle.

In accordance with the invention, the illumination takes place through a gap between the cutting edge and the device for transporting away. Parts of the product such as sausage crumbs or ham crumbs or even whole product slices can collect in this gap during the slicing and hinder the propagation of the radiation used for the illumination through the gap. Fat released by the slicing of the product can, however, also attach itself to the cutting edge and accrete such that the gap gradually closes, with the radiation being more and more hindered from propagation through the gap.

Furthermore, the fat can drip through the gap onto the lighting device or the product parts can fall through the gap and come to lie on the lighting device. In both cases, the lighting device is at least partially covered and propagation of the radiation required for the illumination of the slicing region through the gap is hindered.

To counter such a contamination of the lighting device and/or of the gap, a cleaning device is provided in accordance with the invention for the cleaning of the lighting device and/or of the gap. Thanks to the cleaning device in accordance with the invention, the light path of the radiation used for the illumination of the slicing region can be kept free and illumination of the slicing region of unchanging quality, e.g., with unchanging intensity, can be ensured. A reliable slicing of food products can be ensured in the long term in this manner.

Advantageous embodiments of the invention are recited in the dependent claims, in the description and in the drawing.

The lighting device can thus be made elongate in accordance with a first advantageous embodiment of the invention and can extend parallel to the cutting edge. A homogeneous illumination over the total slicing width can thereby be achieved.

A movable protective cover is advantageously arranged between at least one radiation source of the lighting device and the cutting edge and is transmissible at least regionally for the radiation used for the illumination. The protective cover e.g. prevents fat dripping through the gap or product parts falling through the gap from coming to lie on the radiation source. Since the protective cover is movable, contamination caught by the protective cover can be removed from the propagation path of the radiation used to illuminate the slicing region. Since the protective cover itself transmits radiation, an unimpaired propagation of the radiation can be ensured in this manner.

In a particularly preferred further development of the invention, the protective cover has a protective jacket which is in particular of tube shape, surrounds the radiation source and is rotatably supported about the radiation source. The protective jacket can, for example, rotate continuously about an elongate radiation source. Product parts coming to lie on the protective cover or fat dripping through the gap can be removed by rotating the protective jacket in that they fall off the protective jacket or, with a particularly fast rotation of the protective jacket, are thrown off this or are removed by scrapers or other cleaning members.

In an alternative embodiment, the protective cover is formed by a protective belt movable relative to the radiation source.

The protective belt is preferably a rotating endless belt or is movable by being wound off a first roll and being wound onto a second roll.

In a further advantageous embodiment of the invention, the cleaning device has at least one cleaning member for the mechanical and/or for the contact free cleaning of the lighting device, in particular of the protective cover, and/or of the gap. Due to the cleaning member in accordance with the invention, the cleaning of the lighting device does not take place only due to a self-cleaning effect by, for example, a fast rotation of a protective jacket surrounding the radiation source, but the lighting device is actively cleaned by the cleaning member. Furthermore, in accordance with the invention, a cleaning member can also be provided for the cleaning of the gap so that the gap can also be kept free of contamination and thus an unimpeded propagation of the radiation used for the illumination of the slicing region is ensured from the radiation source to the slicing region.

In a preferred construction embodiment, at least regions of the protective cover are movable through the active region of at least one cleaning member which is in particular stationary relative to the radiation source. A stationary arrangement of the cleaning member permits a particularly simple apparatus arrangement of the cleaning device. Only the protective cover must be made movable. Since the protective cover is moved through the active region of the cleaning member in accordance with the invention, a continuous cleaning of the protective cover can be achieved in particular with a protective jacket rotatably supported about the radiation source or with an endlessly rotating protective belt.

The cleaning device advantageously has at least one ejection member for a cleaning fluid, in particular for compressed air or for at least one liquid pressure jet. The cleaning by means of a cleaning fluid is to be understood as a contact free cleaning within the framework of this invention. It is particularly well suited to the cleaning of the gap since, in this manner, no mechanical aids have to be introduced into the gap for the removal of contamination from the gap which would in turn hinder a propagation of the radiation through the gap in particular with a continuous cleaning of the gap.

In a particularly advantageous construction design of the invention, a cleaning member, in particular in the form of a brush, a wiper, a scraper or a stripper, in uninterrupted contact with the lighting device, in particular in uninterrupted contact with a movable protective cover, is provided for a direct mechanical cleaning. An effective removal of contamination from the protective cover can be realized in a particularly simple manner by such a cleaning member. A wiping lip can thus, for example, be in permanent contact with a protective jacket rotatably supported about the radiation source so that a simple cleaning of the protective jacket and thus an unhindered propagation of the radiation is ensured by a rotation of the protective jacket.

In a further variant of the invention, the cleaning device can be activated for a respective pre-determined time period in particular at regular time intervals or at requirement oriented time intervals. This can contribute to a careful treatment of the cleaning members and in particular to a saving of the cleaning fluid and thus reduce the operating and servicing costs of the cleaning device. The cleaning device can e.g. be activated during the change of product or on blank cuts. A pulsed operation of the cleaning device is also possible in accordance with the invention.

In accordance with a preferred embodiment of the invention, the cleaning device includes a sensor for the detection of contamination of the lighting device and/or of the gap which is made for the activation of a cleaning member when a pre-determined degree of contamination has been exceeded. Due to this embodiment, the cleaning of the lighting device and/or of the gap can be carried out directly as required. A cleaning of the gap can thus take place, for example with the aid of a water pressure jet and of a rotation of the protective jacket by e.g. 90° or 180° only when the intensity of the radiation used for the illumination of the slicing region has dropped beneath a pre-determined intensity value in the slicing region, i.e. when a disturbance of the propagation of the radiation has been determined.

The present invention will be described in the following purely by way of example with reference to an advantageous embodiment and to the enclosed drawing. The single FIGURE shows a schematic representation of a slicer apparatus in accordance with the invention.

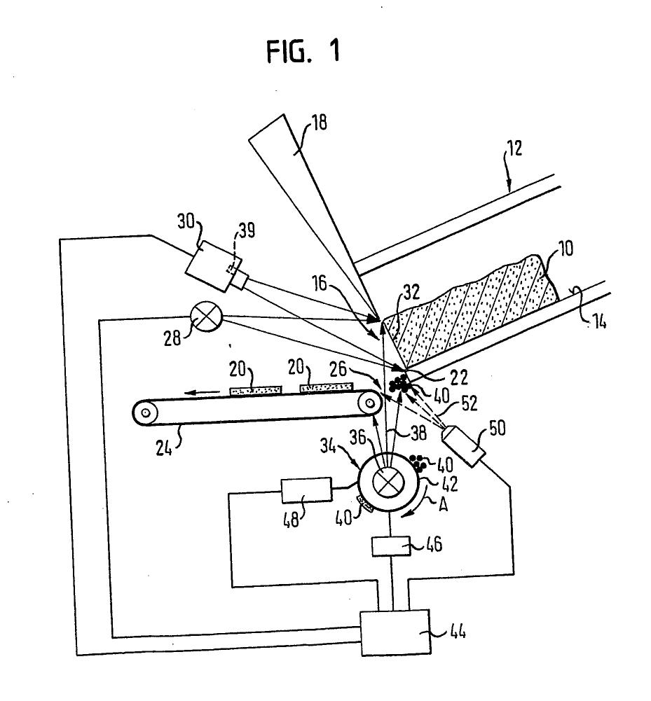

The apparatus in accordance-with the invention shown in FIG. 1 for the slicing of a food product 10 such as sausage, ham or cheese, for example, has a product supply device 12 with a product support surface 14 which is open toward a slicing region 16. The product 10 to be sliced is supported in the supply device 12 on the support surface 14 and can be supplied to the slicing region 16 with the help of a feed device (not shown) engaging at the rear product end. In the slicing region 16, product slices 20 are cut off the product 10 in a rapid sequence with the help of a cutting blade 18, for example a rotating scythe-like blade. For this purpose, a cutting edge 22 is formed at the support surface 14 in the slicing region 16.

The cut-off product slices 20 are transported away from the slicing region 16 individually or portion-wise by means of an endless belt 24. A gap 26, which can have a width in the range from some millimeters up to some centimeters, is present between the device for transporting away 24 and the cutting edge 22.

A radiation source 28 and a detection device 30, e.g. a video camera, are arranged above the cutting edge 22 in the half-space disposed in front of the slicing region 16 The detection device 30 serves for the detection of the cut surface 32 of the product 10 to determine the contour and/or the composition of the individual product slices 20. The slicing region 16 can be illuminated, for example, by the radiation source 28 with such a radiation which emphasizes the fat components of the product 10. The contour and structure information determined can be used, for example, to keep the weight of the product slices 20 cut off constant within pre-determined limits by controlling corresponding control members (hot shown).

A lighting device 34 is provided in addition to the radiation source 28 beneath the cutting edge 22 in the half-space disposed in front of the slicing region. This lighting device 34 can alternatively be the only device for the illumination of the slicing region 16.

The illumination by means of the lighting device 34 takes place through the gap 26 between the cutting edge 22 and the device for transporting away 24. The lighting device 34 is elongate, extends parallel to the cutting edge 22 and has a radiation source 36 which can include only one lighting element, e.g. a fluorescent lamp, or a plurality of lighting elements, for example a plurality of light emitting diodes (LEDs) which can optionally transmit radiation 38 with different wavelengths.

The radiation 38 of the radiation source 36 propagates through the gap 26 and illuminates the slicing region 16. The intensity of the radiation 38 in the slicing region 16 is detected by a sensor 39 which can, for example, be integrated in the detection device 30. If the intensity of the radiation 38 in the slicing region 16 falls below a pre-determined intensity threshold, this can be an indication of the fact that the propagation of the radiation 38 is being hindered by contamination 40 of the gap 26 or of the lighting device 34.

Such contamination 40 can be formed, on the one hand, by fractions of the product or by whole product slices, for example by pieces of sausage or whole slices of sausage, which occur during the slicing process, fall into the gap 26 and get stuck in it or fall through the gap 26 and come to lie on the lighting device 34. On the other hand, the contamination 40 can also be formed by fat which is released during the slicing process and collects at the cutting edge 22. On the one hand, so much fat can accrete at the cutting edge 22 that the gap 26 becomes closed. On the other hand, the fat can drip off the cutting blade 18, the cutting edge 22 and/or the cut surface 32 through the gap 26 onto the lighting device 34 and form a fat film thereon which hinders the propagation of the radiation 38.

To ensure a disturbance-free illumination of the slicing region 16, a cleaning device is provided in accordance with the invention for the cleaning of the lighting device 34 and/or of the gap 26. For this purpose, the lighting device 34 has a protective jacket 42 which is formed in tube-shape, surrounds the radiation source 36 and is rotatably supported about it. The protective jacket 42 transmits the radiation 38 used for the illumination.

The protective jacket 42 can be rotated about the radiation source 36 in the direction of rotation A with the help of a drive 46 controlled by a control 44. The protective jacket 42 is rotatable so far and in particular by 360° such that contamination 40 such as pieces of sausage which have come to lie on it fall off it due to gravity. However, such a high speed of rotation is also possible that stubborn contamination 40 is also thrown off the surface of the protective jacket 42.

The protective jacket 42 can be rotated continuously or at times, i.e. it can be rotated, for example, at pre-determined intervals in each case about pre-determined angles of rotation. However, a requirement oriented rotation of the protective jacket 42 can also be provided in which a rotation of the protective jacket 42 about a pre-determined angle always takes place when a drop in intensity of the radiation 38 is detected in the slicing region 16 by the sensor 39 connected to the control 44 for this purpose.

The cleaning device moreover has a cleaning member for the mechanical cleaning of the protective jacket 42 in the embodiment shown. In this example, a wiping lip 48 is shown which is in contract with the protective jacket 42. When the protective jacket 42 rotates past the wiping lip 48, contamination 40 is wiped off the surface of the protective jacket 42 by the wiping lip 48.

A mechanical cleaning of the protective jacket 42 can also be achieved, instead of by a wiping lip 48, by a brush, a wiper, a scraper or a stripper. In the same manner, a “contact free” cleaning can also be used in which the surface of the protective jacket 42 is cleaned, for example, with the help of a compressed air jet or of a water pressure jet.

Such a contact free cleaning is particularly well suited to the cleaning of the gap 26. In the example, the cleaning device additionally has a nozzle 50 which produces a compressed air jet 52 directed onto the gap 26. Contamination 40 can be removed from the gap 26 by the compressed air jet 52, i.e. the gap 26 can be blown free by the compressed air jet 52.

The ejection member 50 is connected to the control 44 for the control of the ejection member 50 or of the compressed air jet 52. A continuous compressed air jet 52 can be used for the cleaning of the gap 26. A good cleaning result is, however, also achievable by a pulsed compressed air jet 52, which moreover results in a saving of compressed air. Analog to the cleaning of the lighting device 34, a requirement oriented cleaning of the gap 26 is also possible in which the ejection member 50 is only activated by the control 44 when a reduction in the illumination intensity is detected in the slicing region 16 by the sensor 39 connected to the control 44.

Instead of a compressed air jet 52, a pressure jet of another cleaning fluid such as a water pressure jet can also be used to clean the gap 26.

Generally, a cleaning device can also be realized with a single cleaning member which serves both for the cleaning of the illumination device 34 and for the cleaning of the gap 26. This is e.g. an ejection member for a cleaning fluid which is pivotally supported such that it can direct a compressed air jet or a liquid pressure jet onto the gap 26 and onto the lighting device 34 alternately and/or requirement oriented.

An undisturbed propagation of the radiation 38 from the radiation source 36 through the gap 26 into the slicing region 16 is ensured by the cleaning of the lighting device 34 and/or of the gap 26 in accordance with the invention.

### Reference Numeral List

10 product

12 supply device

14 support surface

16 slicing region

18 cutting blade

20 product slice

22 cutting edge

24 device for transporting away

26 gap

28 radiation source

30 detection device

32 cut surface

34 lighting device

36 radiation source

38 radiation

39 sensor

40 contamination

42 protective jacket

44 control

46 drive

48 wiping lip

50 ejection member

52 compressed air jet

A direction of rotation

1. An apparatus for the slicing of food products (10), in particular with an irregular internal structure such as sausage or ham, with which the products are cut into slices (20) and portions, in particular overlapping portions or stacked portions, are formed and are transported away from a slicing region (16), comprising
a cutting edge (22) at which the products (10) are cut;
a device (24), in particular formed by an endless belt, for the transporting away of the product slices (20); and
at least one lighting device (34) for the illumination of the slicing region (16), characterized
in that the lighting device (34) is arranged beneath the cutting edge (22) in the half-space disposed in front of the slicing region (16) such that the illumination takes place through a gap (26) between the cutting edge (22) and the device for transporting away (24); and
in that a cleaning device (42, 44, 46, 48, 50, 52) is provided for the cleaning of the lighting device (34) and/or of the gap (26).

2. An apparatus in accordance with claim 1, characterized in that the lighting device (34) is elongated and extends parallel to the cutting edge (22).

3. An apparatus in accordance with claim 1, characterized in that a movable protective cover (42) is arranged between at least one radiation source (36) of the lighting device (34) and the cutting edge (22) and is transmissible at least regionally for the radiation (38) used for the illumination.

4. An apparatus in accordance with claim 3, characterized in that the radiation source (36) is at least partly surrounded by the protective cover (42).

5. An apparatus in accordance with claim 3, characterized in that the protective cover has a protective jacket (42) which is in particular of tube shape, surrounds the radiation source (36) and is rotatably supported about the radiation source (36).

6. An apparatus in accordance with claim 3, characterized in that the protective cover is formed by a protective belt movable relative to the radiation source (36).

7. An apparatus in accordance with claim 6, characterized in that the protective belt is a rotating endless belt or is movable by being wound off a first roll and being wound onto a second roll.

8. An apparatus in accordance with claim 1, characterized in that the cleaning device has at least one cleaning member (48, 50) for the mechanical and/or for the contact free cleaning of the lighting device (34), in particular of the protective cover (42), and/or of the gap (26).

9. An apparatus in accordance with claim 3, characterized in that at least regions of the protective cover (42) are movable through the active regions of at least one cleaning member (48) which is in particular stationary relative to the radiation source (36).

10. An apparatus in accordance with claim 1, characterized in that the cleaning device has at least one ejection member (50) for a cleaning fluid, in particular for compressed air (52) or for at least one liquid pressure jet.

11. An apparatus in accordance with claim 1, characterized in that a cleaning member (48), in particular in the form of a brush, a wiper, a scraper or a stripper, in uninterrupted contact with the lighting device (34), in particular in uninterrupted contact with a movable protective cover (42), is provided for a direct mechanical cleaning.

12. An apparatus in accordance with claim 1, characterized in that the cleaning device can be activated for a respective pre-determined time period in particular at regular time intervals or at requirement oriented time intervals.

13. An apparatus in accordance with any one of the preceding claims claim 1, characterized in that the cleaning device includes a sensor (39) for the detection of contamination of the lighting device (34) and/or of the gap (26) which is made for the activation of a cleaning member (48, 50) when a pre-determined degree of contamination has been exceeded.
